(19) United States
(12) Patent Application Publication
(10) Pub. No.: US 2006/0215347 A1
(43) Pub. Date: Sep. 28, 2006

(54) Processing apparatus and recording medium

(75) Inventor: Shinji Wakabayashi, Nirasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 11/356,985

(22) Filed: Feb. 21, 2006

Related U.S. Application Data
(60) Provisional application No. 60/666,573, filed on Mar. 31, 2005.

(30) Foreign Application Priority Data
Mar. 28, 2005 (JP) P2005-090832

(51) Int. Cl. H01T 23/00

(52) U.S. Cl. 361/234

(57) ABSTRACT

A processing apparatus includes: a mounting table on which a carriage container containing a plurality of substrates is placed; a process chamber in which predetermined processing is applied to the substrate; a temporary storage unit having a substrate loading part on which the plural processed substrates are loaded in multi-tiers; a transfer unit having a carrier arm carrying the substrate to/from the carriage container on the mounting table, the process chamber, and the temporary storage unit; a vibration sensor detecting vibration of the substrate loading part; and a control unit which compares a current detection value of the vibration sensor with a predetermined set value to judge whether or not the vibration is abnormal vibration and to stop the carrier arm when judging that the vibration is the abnormal vibration.

### CROSS-REFERENCE TO RELATED APPLICATION

This application is based upon and claims the benefit of priority from the prior Japanese Patent Application No. 2005-090832, filed on Mar. 28, 2005; and the prior U.S. Patent Provisional Application No. 60/666,573, filed on Mar. 31, 2005; the entire contents which are incorporated herein by reference.

### BACKGROUND OF THE INVENTION

1. Field of the Invention

The present invention relates to a processing apparatus and a recording medium, and more particularly, to an art of detecting chipping of a substrate.

2. Description of the Related Art

The manufacture of a semiconductor device includes processes of applying various kinds of processing, for example, etching and so on to, for example, a semiconductor wafer (hereinafter referred to as a wafer) which is a substrate to be processed, and a processing apparatus is used for implementing these processes. The processing apparatus includes: a FOUP mounting table on which a FOUP (Front Opening Unified Pod) as a carriage container containing a plurality of, for example, 25 wafers is placed; a process chamber in which predetermined processing is applied to the wafer; a purge storage as a temporary storage unit having a substrate loading part on which the plural processed wafers are loaded in multi-tiers; and a transfer unit having a carrier arm carrying the wafer to/from the FOUP on the FOUP mounting table, the process chamber, and the purge storage.

After the wafers undergo, for example, the etching under a predetermined process gas atmosphere in the process chamber, the carrier arm carries and loads the wafers on the substrate loading part of the purge storage, and process gas remaining near surfaces of the wafers (hereinafter referred to as residual gas) is removed (purged) by clean air circulated in and exhausted from the purge storage.

Incidentally, in some cases, the wafer floats to be displaced due to poor destaticization of an electrostatic chuck which is provided in the process chamber to hold the wafer. Due to this displacement, when the wafer is supported by a pick part which is a wafer supporting part in the carrier arm, it also deviates from the proper position. Accordingly, when the wafer is loaded on the substrate loading part by the carrier arm, a peripheral edge portion of the wafer sometimes collides in part with the substrate loading part to suffer chipping due to the shock of the collision.

The chipping of the wafer may possibly lead to breakage of the wafer in subsequent processes. The chipping tends to be a starting point of the breakage of the wafer especially in a heating process. In a vertical heating apparatus of a 4-lot batch processing type that processes wafers corresponding to four FOUPs at one time, 100 wafers can be loaded on a wafer board at the maximum, and if the top wafer suffers a crack and drops, the wafers on lower tiers are broken one after another, which may possibly result in an enormous loss.

However, a conventional processing apparatus is not provided with a function of detecting the chipping of a wafer. Accordingly, a wafer suffering the chipping is carried and put in the FOUP without any error detection, which may possibly cause a wafer crack and a defective lot in subsequent processes.

As a related art, proposed is a semiconductor manufacturing device in which vibration sensors are provided in tweezers (corresponding to the pick part) being a wafer supporting part in a wafer carrier, in order to prevent the wafer from being scratched on its surface when the tweezers come into contact with the wafer due to poor bending, poor adjustment, and the like of the tweezers (see, for example, Japanese Patent Laid-open Application No. 2001-223254). However, in this semiconduct or manufacturing device, it is difficult to discriminate vibration accompanying operations of the wafer carrier itself from vibration accompanying the contact of the wafer, and in addition, since the wafer slides on the tweezers when the wafer collides therewith, there is a possibility that the vibration accompanying the collision of the wafer is not conveyed to the tweezers.

As another related art, also proposed is a vertical heating apparatus in which a vibration sensor is provided in a boat as a carrier, in order to prevent the occurrence of particles due to vibration (see Korean Patent Publication No. 2001-45630).

### SUMMARY OF THE INVENTION

As previously described, the aforesaid processing apparatus can detect neither the displacement of the wafer occurring in the process chamber nor the chipping of the wafer occurring when the processed wafer is carried and loaded on the substrate loading part of the temporary storage unit from the process chamber. This involves the possibility that the wafer suffering the chipping is carried and put in the FOUP without any error detection and is cracked or broken in the subsequent processes.

The present invention was made in consideration of the above-described circumstances, and its object is to provide a processing apparatus and a recording medium that realize easy detection of chipping of a substrate which sometimes occurs when the processed substrate is carried and loaded on a substrate loading part of a temporary storage unit, and thus realizes the prevention of the breakage of the substrate in subsequent processes. It is another object of the present invention to provide a processing apparatus and a recording medium that realize easy detection of the displacement of a substrate occurring in a process chamber or on a transfer route.

One embodiment of a processing apparatus of the present invention is a processing apparatus processing a substrate and including: a mounting table on which a carriage container containing the plural substrates is placed; a process chamber in which predetermined processing is applied to the substrate; a temporary storage unit having a substrate loading part on which the plural processed substrates are loaded in multi-stage; a transfer unit having a carrier arm carrying the substrate to/from the carriage container on the mounting table, the process chamber, and the temporary storage unit; a vibration sensor detecting vibration of the substrate loading part; and a control unit which compares a current detection value of the vibration sensor with a predetermined set value to judge whether or not the vibration is abnormal vibration and to stop the carrier arm when judging that the vibration is the abnormal vibration.

Another embodiment of the processing apparatus of the present invention is the aforesaid processing apparatus, wherein the temporary storage unit is a purge storage in which clean air flowing into the temporary storage unit is exhausted to purge residual gas around the substrates.

A still another embodiment of the processing apparatus of the present invention is the aforesaid processing apparatus, wherein the substrate loading part includes: a plurality of support columns each made of a heat-resistant material and having multi-tiered holding grooves holding peripheral edge portions of the substrates; and heating members provided in the respective support columns to heat the support columns to a predetermined temperature.

Yet another embodiment of the processing apparatus of the present invention is the aforesaid processing apparatus that further includes a data collecting/recording unit collecting/recording, in time sequence, data outputted from the vibration sensor.

One embodiment of a recording medium of the present invention is a recording medium storing a program that causes a computer to execute transfer of a substrate to a temporary storage unit by a carrier arm, the program including: a vibration detection module detecting, by using a vibration sensor, vibration that occurs from a substrate loading part of the temporary storage unit when the substrate is loaded on the substrate loading part by the carrier arm; a judgment module judging whether or not the vibration is abnormal vibration by comparing a current detection value of the vibration sensor with a predetermined set value; and a carrier arm stop module stopping the carrier arm when the judgment module judges that the vibration is the abnormal vibration.

Another embodiment of the recording medium of the present invention is a recording medium storing a program that causes a computer to execute transfer of a substrate to a temporary storage unit by a carrier arm, the program including: a vibration detection module detecting, by using a vibration sensor, vibration that occurs from a substrate loading part of the temporary storage unit when the substrate is loaded on the substrate loading part by the carrier arm; a judgment module judging whether or not the vibration is abnormal vibration by comparing a current detection value of the vibration sensor with a predetermined set value; and a substrate damage detection module detecting that the substrate is damaged in a peripheral edge portion, based on the judgment of the abnormal vibration by the judgment module.

Another embodiment of the recording medium of the present invention is a recording medium storing a program that causes a computer to execute transfer of a substrate to a temporary storage unit by a carrier arm, the program including: a vibration detection module detecting, by using a vibration sensor, vibration that occurs from a substrate loading part of the temporary storage unit when the substrate is loaded on the substrate loading part by the carrier arm; a judgment module judging whether or not the vibration is abnormal vibration by comparing a current detection value of the vibration sensor with a predetermined set value; and a displacement detection module detecting that the substrate is displaced in a process chamber or on a transfer route, based on the judgment of the abnormal vibration by the judgment module.

Still another embodiment of the recording medium of the present invention is either of the aforesaid recording media, wherein the program further includes a substrate collection module collecting the substrate supported by the carrier arm in a carriage container different from a normally used carriage container when the judgment module judges that the vibration is the abnormal vibration.

Yet another embodiment of the recording medium of the present invention is either of the aforesaid recording media, wherein the program further includes a substrate retreat module that causes the substrate supported by the carrier arm to temporarily retreat in a dummy FOUP or a dummy stocker when the judgment module judges that the vibration is the abnormal vibration.

### BRIEF DESCRIPTION OF THE DRAWINGS

FIG. 1 is a plane view showing a rough structure of a processing apparatus according to an embodiment of the present invention.

FIG. 2A and FIG. 2B are views showing a pick part of a carrier arm, FIG. 2A being a plane view and FIG. 2B being a front view.

FIG. 3 is a plane view showing a rough structure of a purge storage.

FIG. 4 is a front view roughly showing an essential portion of a substrate loading part.

FIG. 5 is a diagram showing a rough configuration of a system controller in the processing apparatus in FIG. 1.

FIG. 6 is a plane view showing a rough structure of a modification example of the processing apparatus according to the embodiment of the present invention.

FIG. 7 is a view roughly showing a side portion of a loader unit.

FIG. 8A and FIG. 8B are charts to illustrate a series of processing flows in the processing apparatus, FIG. 8A being a flowchart for a normal case and FIG. 8B being a flowchart when abnormality is detected.

### DESCRIPTION OF THE EMBODIMENTS

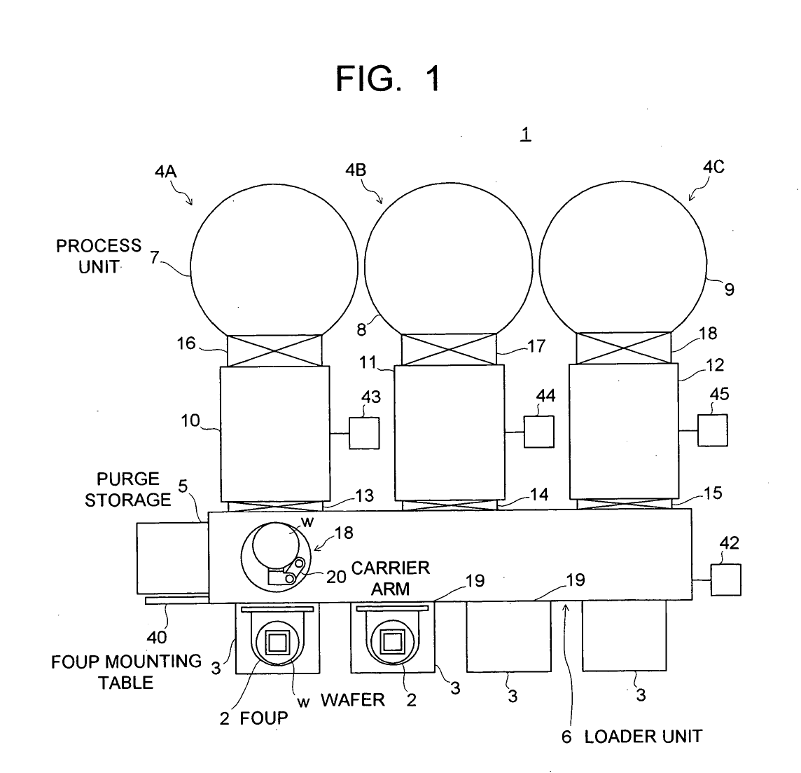

Hereinafter, the best mode for carrying out the present invention will be described with reference to the drawings. FIG. 1 is a plane view showing a rough structure of a processing apparatus according to an embodiment of the present invention.

In FIG. 1, 1 denotes a single-wafer processing apparatus in which semiconductor wafers (hereinafter referred to as wafers) W as substrates to be processed are carried and undergo predetermined processing one by one. The processing apparatus 1 includes: a plurality of, for example, four FOUP mounting tables 3 as mounting tables on which FOUPs 2 as carriage containers each containing a plurality of, for example, 25 wafers W are placed; three process ships 4A, 4B, 4C each including a process unit (process chamber) in which predetermined processing, for example, etching is applied to the wafer W; a purge storage 5 as a temporary storage unit temporarily storing the plural processed wafers W in multi-tiers; and a loader unit 6 being a transfer unit transferring the wafers W to/from the FOUPs 2 on the FOUP mounting tables 3, the process ships 4A to 4C, and the purge storage 5.

The process ships 4A to 4C have: process units 7, 8, 9 each being a process chamber, for example, a vacuum process chamber in which predetermined processing is applied to the wafer W; load lock units 10, 11, 12 having therein carrier arms (not shown) transferring the wafers W to/from the process units 7 to 9. Each of the process units 7 to 9 has a cylindrical chamber (process chamber) and upper and lower electrodes disposed in the chamber, and an appropriate interval is set between the upper electrode and the lower electrode so as to allow the wafer W to undergo etching, for example, reactive ion etching. Further, the lower electrode has on its top portion an electrostatic chuck holding the wafer W by a Coulom force or the like.

In each of the process units 7 to 9, process gas is introduced into the chamber and an electric field is generated by the electrodes, so that the process gas is turned into plasma to cause ion and radical generation, whereby the reactive ion etching is applied to the wafer W by the ions and radicals. Further, in each of the process units 7 to 9, corrosive gas (for example, NH₃) and HF are introduced into the chamber and isotropy etching is applied to the wafer W by COR (Chemical Oxide Removal) without using an electric field. Internal pressure of the process units 7 to 9 in the process ships 4A to 4C is kept vacuum, while internal pressure of the loader unit 6 is kept at an atmospheric pressure. Therefore, the load lock units 10 to 12 have gate valves 13, 14, 15 at coupling portions with the loader unit 6 and gate valves 16, 17, 18 at coupling portions with the process units 7 to 9, so that the load lock units 10 to 12 are constituted as vacuum preliminary transfer chambers whose internal pressure is adjustable.

The loader unit 6 is in a laterally long box shape, and clean air is introduced thereinto from an upper side thereof via a filter. The loader unit 6 has: a carrier arm mechanism 18 provided therein; and four load ports 19 as wafer inlets disposed on one sidewall (front side) facing the FOUP mounting tables 3. The number of the load ports may be three, or may be increased to four or more so as to be adapted to a mass-production clean room when necessary. The three process ships 7 to 9 are connected to another sidewall (a rear side) of the loader unit 6. The carrier arm mechanism 18 has: an X-axis moving part which is capable of reciprocal movement along a guide rail (not shown) extending in a longitudinal direction in the loader unit 6 when driven by an electromagnet; a turn table horizontally turnable via a Z-axis moving part ascendably/descendably provided on the X-axis moving part; and a multi-joint carrier arm 20 provided on the turn table to be stretchable/contractible in a radial direction or a horizontal direction.

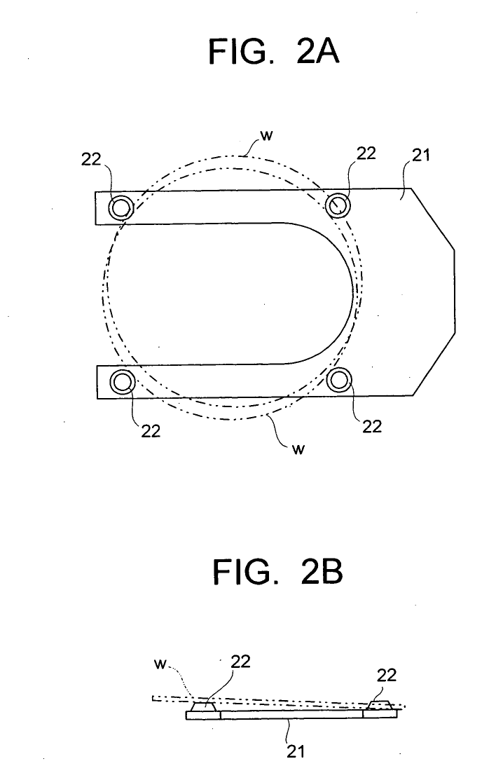

The carrier arm 20 has at its tip a pick part 21 supporting the wafer W. FIG. 2A and FIG. 2B are views showing the pick part 21 of the carrier arm 20, FIG. 2A being a plane view and FIG. 2B being a front view. The pick part 21 is made of, for example, a ceramic thin plate in a U shape in a plane view, and has on its upper face portion a plurality of, for example, four tapered restriction pins 22, which come in contact with a peripheral edge portion of the wafer W, for wafer alignment at a predetermined position (proper position). Normally, the wafer W is restricted by the restriction pins 22 to be horizontally supported on the pick part 21. However, if the wafer W is displaced due to, for example, poor destaticization of the electrostatic chucks in the process units 7 to 9 and is supported by the pick part 21 of the carrier arm 20 while kept displaced, the wafer W is sometimes supported while protruding toward one side or protruding toward one side and inclining as shown by the two-dot. chain line in FIG. 2B.

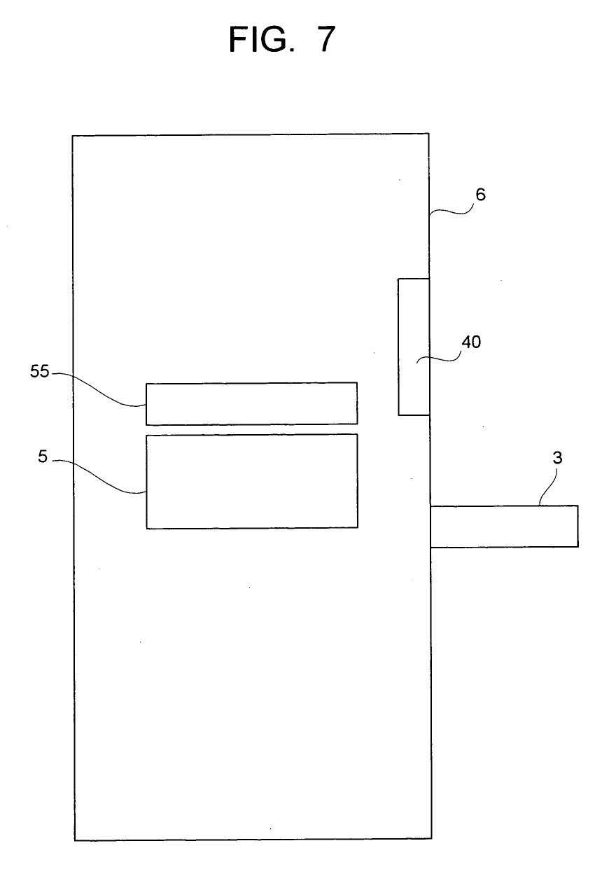

The purge storage 5 is connected to one longitudinal end of the loader unit 6. An orienter 55 pre-aligning the position of the wafer W carried into the loader unit 6 from the FOUP 2 is also connected to the longitudinal end of the loader unit 6, and the orienter 55 and the purge storage 5 are vertically stacked (see FIG. 7). Either of the orienter 55 and the purge storage 5 may be arranged on the top or on the bottom. The wafer W is carried to the purge storage 5 and the orienter 55 by the carrier arm 20.

The carrier arm 20 is movable up/down at a 25-pitch stroke so as to be capable of carrying the 25 wafers W contained in the FOUP 2 in multi-tiers. However, since the orienter 55 is disposed on the purge storage 5, the number of the wafers W stored in the purge storage 5 is limited to 19. Incidentally, arranging the orienter 55 at the longitudinal end of the loader unit 6 and the purge storage 5 at the other longitudinal end of the loader unit 6 allows the purge storage 5 to store the 25 wafers.

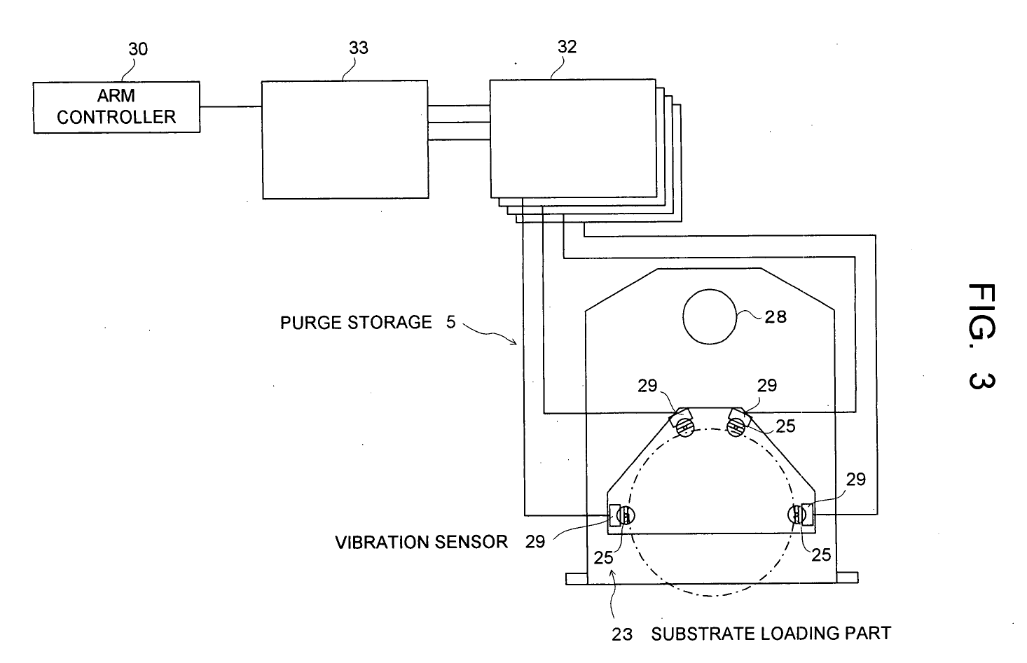

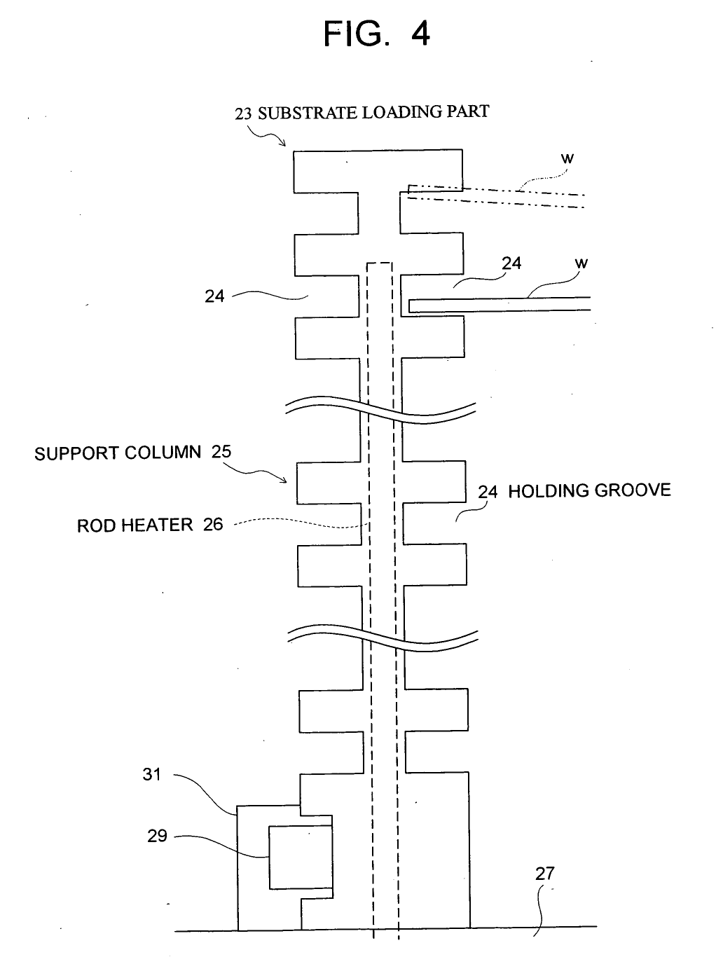

FIG. 3 is a plane view showing a rough structure of the purge storage 5. FIG. 4 is a front view roughly showing an essential portion of a substrate loading part 23. The purge storage 5 is in a box shape with a loader unit 6 side end being open, and has therein the substrate loading part 23 on which the plural, for example, 19 wafers W are loaded in multi-tiers. The substrate loading part 23 includes: a plurality of, for example, four ceramic support columns 25 having multi-tiered holding grooves 24 for holding the peripheral edge portions of the wafers W; and rod heaters 26 as heating members which are provided inside the respective support columns 25 to heat the support columns 25 to a predetermined temperature. The support columns 25 stand on a base plate 27 provided in the purge storage 5.

The rod heaters 26 heat the support columns 25 of the substrate loading part 23 to the predetermined temperature, for example, about 60° C. in order to prevent reaction by-products from adhering and depositing on the substrate loading part 23 due to the contact of the residual gas remaining around the processed wafers W to thereby make a cleaning cycle of the purge storage 5 longer. The support columns 25 are made of a heat-resistant material, for example, ceramics so as to be resistible against this heating temperature. Besides ceramics, examples of other possible heat-resistant materials forming the support columns 25 are a carbon rod, quartz glass, glass fiber reinforced polyethylene telephthalate (GF-PET), heat-resistant resin (aromatic polyamide, PES, PEEK, PEK, LCP, thermoplastic PI, super heat-resistant silicon polymer, PCT resin, and a nylon nano-composite made by complexing a base material and nano-filler such as nano-particle, nano-tube, nano-horn added to the base material). Preferably, each of the support columns 25 has, on both sides thereof, the holding grooves 24 provided substantially symmetrically so that the support column 25 does not warp.

The purge storage 5 has an exhaust port 28 through which the clean air flowing therein from the loader unit 6 side is exhausted, so that the residual gas around the wafers W is purged therethrough together with the clean air. The exhaust port 28 is connected to a factory exhaust system provided with a detoxifier.

As previously described, when the wafer W is loaded on the substrate loading part 23, part of the peripheral edge portion of the wafer W, if supported by the pick part 21 of the carrier arm 20 in a protruding state toward one side, sometimes comes into contact or collide with the substrate loading part 23 as shown by the two-dot chain line in FIG. 4 to suffer chipping due to the shock thereof. Therefore, vibration sensors 29 detecting vibration of the substrate loading part 23 are provided in the substrate loading part 23 in order to detect the vibration generated from the substrate loading part 23, whereby the chipping of the wafer W is detected.

A vibration acceleration occurring when the carrier arm 20 supports and carries the wafer W or when it moves greatly differs from that when the wafer W collides with the substrate loading part 23 (an S/N ratio is large), the former being 2 m/s² or lower, while the latter being 20 m/s² or more. Therefore, it is possible to easily detect the occurrence of the collision of the wafer W in the substrate loading part 23, and as a result, to detect the chipping of the wafer W caused by the collision. A detection value of the vibration sensors 29 is not limited to the vibration acceleration, but an alternative configuration may be such that the vibration sensors 29 detect a frequency component when the vibration occurs and the detected frequency component is compared with a set value.

The processing apparatus 1 includes an arm controller 30 as a control unit which compares a current detection value of each of the vibration sensors 29 with a predetermined set value to judge whether or not the vibration is abnormal vibration, and when judging that the vibration is the abnormal vibration, stops the operation of the carrier arm 20. The vibration sensors 29 are preferably attached on base portions (lower portions) of the respective support columns 25. Further, preferably, protective covers 31 are provided on the vibration sensors 29 in order to protect the vibration sensors 29 from the corrosive residual gas. The vibration sensors 29, unlike an optical sensor, have an advantage of being capable of exerting the detection function even if covered by the protective covers 31 and being unsusceptible to the influence of the adhesion of the reaction by-product.

Detection signals (output signals) from the vibration sensors 29 are inputted to sensor amplifiers 32, and each of the sensor amplifiers 32 compares the current detection value with the predetermined set value and judges whether the vibration is abnormal vibration (NG) or not (OK), based on whether or not the detection value exceeds the set value. In this system, output signals from the sensor amplifiers 32 are inputted as digital signals to the arm controller 30 via an interface board 33, and in the case of the abnormal vibration, the carrier arm 20 is interlocked for stopping. At this time, an alarm may be operated at the same time. The interface board 33 includes an OR gate, a holding/resetting circuit, and a mask. The mask is set so as to allow the signal to pass therethrough, for example, only when the carrier arm 20 is in a stretched state.

The processing apparatus 1 includes: a system controller controlling operations of the three process ships 4A to 4C and the loader unit 6; and an operation controller 40 disposed at the longitudinal end of the loader unit 6. The operation controller 40 has a display part constituted of, for example, a LCD (Liquid Crystal Display) and displaying operation statuses of the respective components of the processing apparatus 1.

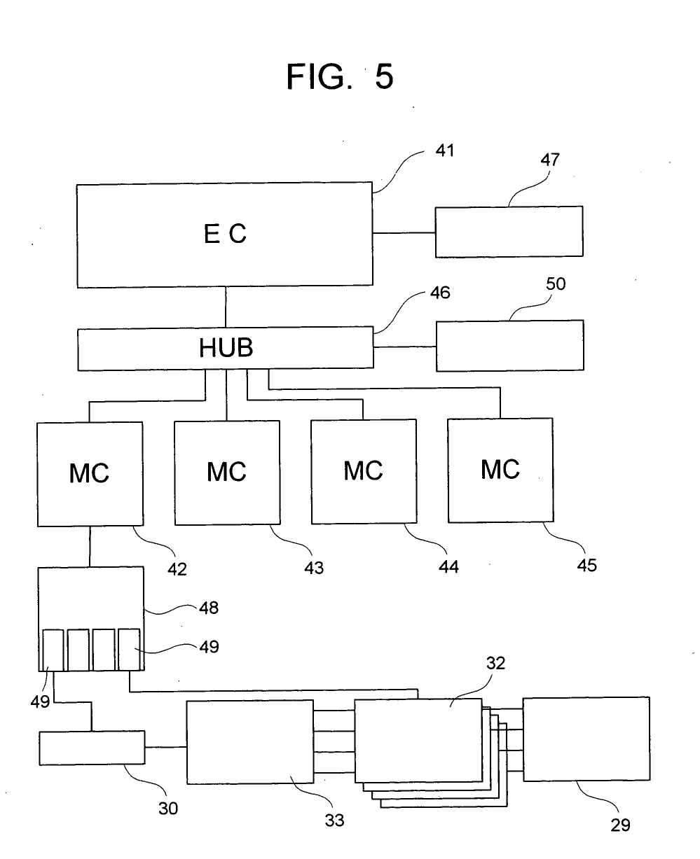

FIG. 5 is a diagram showing a rough configuration of the system controller in the processing apparatus in FIG. 1. As shown in FIG. 5, the system controller includes an EC (Equipment Controller) 41, four MCs (Module Controllers) 42, 43, 44, 45, and a switching hub 46 connecting the EC 41 and the MCs 42 to 45. The EC 41 of the system controller is connected via LAN (Local Area Network) to a host computer 47 serving as a MES (Manufacturing Execution System) which controls the whole manufacturing processes in a factory where the processing apparatus 1 is installed. The host computer 47 works in association with the system controller to feed back real-time information regarding the processes in the factory to a basic task system (not shown) and to also make judgment on the processes in consideration of the load and the like of the whole factory.

The EC 41 is a main control unit (a master control unit) centrally controlling the MCs 42 to 45 to control the operations of the whole processing apparatus 1. Further, the EC 41 has a CPU, a RAM, a HDD, and so on and controls the operations of the process ships 4A to 4C and the loader unit 6 by the CPU transmitting control signals to the MCs 42 to 45 according to a wafer processing method, that is, a recipe, that a user or the like designates in the operation controller 40.

The switching hub 46 selects a connection destination of the EC 41 from the MCs 42 to 45 according to the control signal sent from the EC 41. The MCs 42 to 45 are sub-control units (slave control units) controlling the operations of the process ships 4A to 4C and the loader unit 6. The MCs 42 to 45 are connected to respective I/O (input/output) modules 48 via a GHOST network (a network realized by an LSI called GHOST (General High-Speed Optimum Scalable Transceiver). In the GHOST network, the MCs 42 to 45 correspond to masters and the I/O modules 48 correspond to slaves.

The I/O module 48, which has a plurality of I/O parts 49 connected to respective components (end devices) of the loader unit 6, transmits control signals to the end devices and transmits output signals sent from the end devices. An I/O board controlling the input/output of digital signals, analog signals, and serial signals in the I/O parts 49 is also connected to the GHOST network.

In the system controller in FIG. 5, the plural end devices are not directly connected to the EC 41, but the I/O parts 49 connected to the plural end devices are made as a module to constitute each of the I/O modules 48, and the I/O modules 48 are connected to the EC 41 via the MCs 42 to 45 and the switching hub 46. This can simplify a communication system.

Further, the control signal transmitted by the CPU of the EC 41 includes an address of the I/O part 49 connected to a desired end device and an address of the I/O module 48 including this I/O part 49. Therefore, the GHOST of the MCs 42 to 45 only needs to refer to the address of the I/O part 49 included in the control signal, which frees the switching hub 46 and the MCs 42 to 45 from a need to ask the CPU for a transmission destination of the control signal. This can realize smooth transmission of the control signal.

The system controller further includes a data collection server 50 as a data collecting/recording unit collecting/recording, in time sequence, data outputted from the vibration sensors 29. In this case, detection signals, which are the data outputted from the vibration sensors 29, are taken out as analog signals from the sensor amplifiers 32 to be inputted to the I/O part 49 and then are inputted to the data collection server 50 via the network.

The processing apparatus 1 as configured above includes: the FOUP mounting tables 3 on which the FOUPs 2 each containing the plural wafers W are placed; the process ships 4A to 4C including the process units in each of which predetermined processing is applied to the wafer W; the purge storage 5 having the substrate loading part 23 on which the plural processed wafers W are loaded in multi-tiers; the loader unit 6 having the carrier arm 20 carrying the wafer W to/from the FOUPs 2 on the FOUP mounting tables 3, the process ships 4A to 4C including the process units, and the purge storage 5; the vibration sensors 29 detecting the vibration of the substrate loading part 23; and the arm controller 30 which compares the current detection value of the vibration sensor 29 with the predetermined set value to judge whether or not the vibration is the abnormal vibration and to stop the operation of the carrier arm 20 when judging that the vibration is the abnormal vibration. With this configuration, it is possible to easily detect the chipping of the wafer W which sometimes occurs when the processed wafer W is carried and loaded on the substrate loading part 23 of the purge storage 5, so that the breakage of the wafer W in subsequent processes can be prevented. When the subsequent process is a heating process by a vertical heating apparatus of a batch processing type, one chipping detection can prevent a loss of 100 wafers at the maximum.

Further, the purge storage 5 is structured such that the clean air flowing into the purge storage 5 is exhausted, thereby purging the residual gas around the wafers W, Therefore, it is possible to remove the residual gas around the processed wafers W before the processed wafers W are returned to the FOUPs 2, so that quality deterioration or contamination of the wafers W ascribable to the residual gas around the processed wafers W can be prevented. Moreover, the substrate loading part 23 has: the plural ceramic support columns 25 having the multi-tiered holing grooves 24 holding the peripheral edge portions of the wafers W; and the rod heaters 26 which are provided in the respective support columns 25 to heat the support columns 25 to the predetermined temperature. Therefore, it is possible to prevent the reaction by-product from adhering to the substrate loading part 23 due to the residual gas around the wafers W, which can shorten the cleaning period. In addition, the processing apparatus 1 includes the data collection server 50 as the data collecting/recording unit collecting/recording, in time sequence, the data outputted from the vibration sensors 29, which facilitates analysis for determining the specific wafer W suffering the chipping and the time the chipping occurs.

The objects of the present invention are also attained in such a manner that the EC 41 is supplied with a software program realizing the above-describe functions of the embodiment or with a recording medium (storage medium) recording the program, and the CPU of the EC 41 reads and executes the program stored in the recording medium. In this case, the program read from the recording medium itself realizes the above-described functions of the embodiment, and the program and the recording medium recording the program constitute the present invention.

A program causing a computer to execute the transfer of the wafer W to the purge storage 5 by the carrier arm 20 includes: a vibration detection module detecting, by the vibration sensor 29, vibration that occurs from the substrate loading part 23 when the wafer W is loaded on the substrate loading part 23 of the purge storage 50 by the carrier arm 20; a judgment module judging whether or not the vibration is abnormal vibration by comparing a current detection value of the vibration sensor 29 with the predetermined set value; and a carrier arm stop module stopping the carrier arm 20 when it is judged that the vibration is the abnormal vibration. According to the program, it is possible not only to easily detect the chipping of the wafer W which sometimes occurs when the processed wafer W is carried and loaded on the substrate loading part 23 of the purge storage 5 but also to stop the carrier arm 20, so that the breakage of the wafer W in subsequent processes can be prevented.

Examples usable as the recording medium for supplying the program are a floppy (registered trademark) disk, a hard disk, a magneto-optic disk, a CD-ROM, a CD-R, a CD-RW, a DVD-ROM, a DVD-RAM, a DVD-RW, a magnetic tape, and the like. Alternatively, the program may be downloaded via a network.

Another possible example of the program may include: a vibration detection module detecting, by the vibration sensor, vibration that occurs from the substrate loading part when the wafer is loaded on the substrate loading part of the purge storage by the carrier arm; a judgment module judging whether or not the vibration is abnormal vibration by comparing a current detection value of the vibration sensor with a predetermined set value; and a chipping detection module indirectly detecting, based on the judgment of the abnormal vibration, that the wafer has suffered chipping. According to this program, it is possible to easily detect the chipping of the wafer which sometimes occurs when the processed wafer is carried and loaded on the substrate loading part of the purge storage, so that the breakage of the substrate in subsequent processes can be prevented.

Still another example of the program may include: a vibration detection module (vibration detection step) detecting, by the vibration sensor, vibration that occurs from the substrate loading part when the wafer is loaded on the substrate loading part of the purge storage by the carrier arm; a judgment module judging whether or not the vibration is abnormal vibration by comparing a current detection value of the vibration sensor with a predetermined set value; and a displacement detection module (displacement detection step) indirectly detecting that the wafer is displaced in the process chamber or on a transfer route, based on the judgment of the abnormal vibration. According to this program, it is possible to easily detect the displacement of the wafer occurring in the process chamber or on the transfer route.

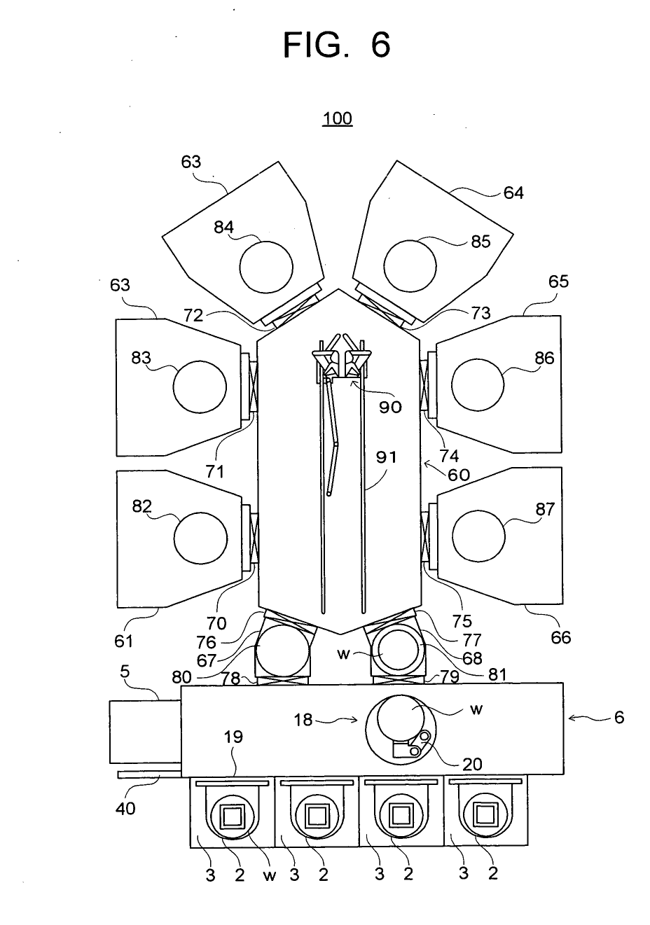

FIG. 6 is a plane view showing a rough structure of a modification example of the processing apparatus according to the embodiment of the present invention. Note that in FIG. 6, the same reference numerals are used to designate the same components as the components in the processing apparatus in FIG. 1, and description thereof will be omitted.

In FIG. 6, a processing apparatus 100 includes: a transfer unit 60 in a vertically long hexagonal shape in a plane view; six process units 61, 62, 63, 64, 65, 66 radially arranged around the transfer unit 60; a loader unit 6; and two load lock units 67, 68 provided between the loader unit 6 and the transfer unit 60 to couple the loader unit 6 and the transfer unit 60. Inner pressure of the transfer unit 60 and the process units 61 to 66 is kept vacuum, and the transfer unit 60 is connected to the process units 61 to 66 via gate valves 70, 71, 72, 73, 74, 75 respectively.

In the processing apparatus 100, inner pressure of the loader unit 6 is kept at atmospheric pressure, while the inner pressure of the transfer unit 60 is kept vacuum. Therefore, the load lock units 67, 68 have gate valves 76, 77, 78, 79 at coupling portions with the transfer unit 60 and at the coupling portions with the loader unit 6 respectively, so that the load lock units 67, 68 are constituted as vacuum preliminary chambers whose inner pressure is adjustable. Further, the load lock units 67, 68 have wafer mounting tables 80, 81 for temporarily placing thereon the wafers W transferred between the loader unit 6 and the transfer unit 60.

The process units 61 to 66 respectively have wafer mounting tables 82, 83, 84, 85, 86, 87 for placing thereon the wafers to be processed. The transfer unit 60 includes a carrier arm unit 90 including two carrier arms of a SCARA arm type. The carrier arm unit 90 moves along guide rails 91 extending in a longitudinal direction in the transfer unit 60 to carry the wafers W to/from the process units 61 to 66 and the load lock units 67, 68. The processing apparatus 100 can also provide the same effects as those of the processing apparatus 1 in FIG. 1.

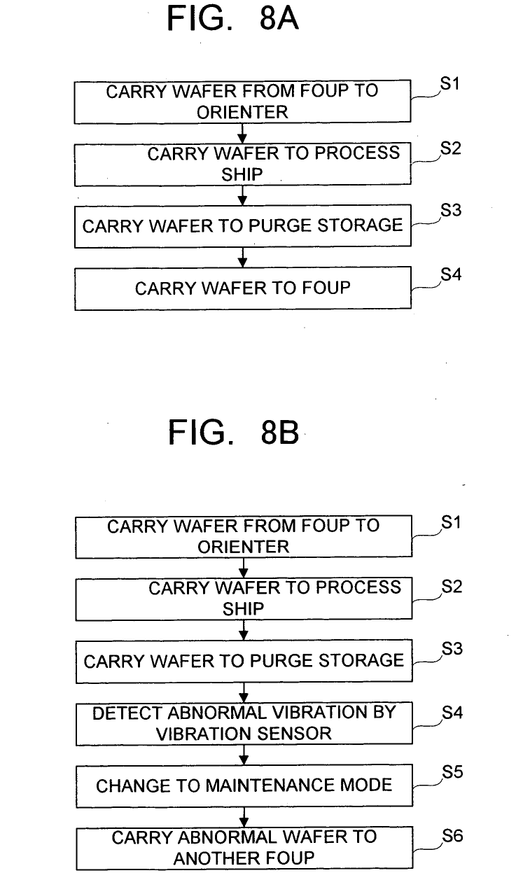

FIG. 8A and FIG. 8B are charts to illustrate a series of processing flows in the processing apparatus, FIG. 8A being a flowchart for a normal case and FIG. 8B being a flowchart when abnormality is detected. In the normal case, as shown in FIG. 8A, the wafer W is carried by the carrier arm 20 from the FOUP 2 to the orienter being an alignment mechanism (S1); the orientation of the wafer W (that is, the position of an orientation flat or a notch) is aligned and the wafer W is carried to the process ship (S2); predetermined processing such as etching is applied to the wafer W and the processed wafer W is carried to the purge storage 5 (S3); and gas adsorbed by the wafer W is purged and the wafer W is carried to the FOUP 2 (S4).

When the processing apparatus is normally operating, the MC 42 for the loader unit 6 and the EC 41 execute the above-described processes as a normal mode. On the other hand, if abnormality occurs because the wafer W is not normally loaded in the temporary storage unit, different processes are executed. These processes will be described with reference to FIG. 8B. For example, when the wafer W is displaced in any of the process ships 4A to 4C for some reason, part of the wafer W collides with the substrate loading part 23 when the wafer W is carried and loaded in the purge storage 5 by the carrier arm 20, and the vibration sensor 29 detects abnormal vibration based on the shock (a vibration acceleration, a vibration frequency, or the like) at this time (S4). Then, the sensor amplifier 32 outputs a signal indicating the judgment of the abnormal vibration (NG) to the arm controller 30, the arm controller 30 selects an abnormal mode to temporarily stop driving the carrier arm 20, and a mode of the MC 42 for the loader unit 6 and the EC 41 is changed to a maintenance mode (S5).

In the maintenance mode, the carrier arm 20 does not carry the abnormal wafer W to the FOUP as originally planned, but carries it to another FOUP for collection (S6). In this case, the abnormal wafer W may be temporarily made to retreat in a dummy FOUP or a dummy stocker (not shown) where a dummy wafer is on standby. Alternatively, the abnormal wafer W may be taken out by a worker. In the maintenance mode, automatic setup processing may be automatically executed to automatically check process condition values of pressure, flow rate of the process gas, temperature, power, and the like, thereby returning these values to normal values (initial set values).

Hitherto, the embodiment or the example of the present invention has been described in detail with reference to the drawings, but the present invention is not limited to the above-described embodiment or example. Various kinds of design changes and the like may be made without departing from the spirit of the present invention. For example, the process units in the processing apparatus may apply CVD processing and the like, or may apply atmospheric pressure processing.

What is claimed is:

1. A processing apparatus processing a substrate, comprising:
a mounting table configured to provide with a carriage container containing the plural substrates;
a process chamber applying a predetermined processing to the substrate;
a temporary storage unit having a substrate loading part configured to load the plural processed substrates in multi-stage;
a transfer unit having a carrier arm carrying the substrate to/from the carriage container on the mounting table, the process chamber, and the temporary storage unit;
a vibration sensor detecting vibration of the substrate loading part; and
a control unit configured to compare a current detection value of the vibration sensor with a predetermined set value to judge whether or not the vibration is abnormal vibration and to stop the carrier arm when judging the vibration to be the abnormal vibration.

2. The processing apparatus as set forth in claim 1,
wherein the temporary storage unit is a purge storage in which clean air flowing into said temporary storage unit is exhausted to purge residual gas around the substrates.

3. The processing apparatus as set forth in claim 1,
wherein the substrate loading part includes: a plurality of support columns each made of a heat-resistant material and having multi-tiered holding grooves holding peripheral edge portions of the substrates; and heating members provided in the respective support columns to heat the support columns to a predetermined temperature.

4. The processing apparatus as set forth in claim 1, further comprising a data collecting/recording unit collecting/recording, in time sequence, data outputted from the vibration sensor.

5. A recording medium storing a program configured to cause a computer to execute transfer of a substrate to a temporary storage unit by a carrier arm, the program comprising:
a vibration detection module detecting, by using a vibration sensor, vibration occurred from a substrate loading part of the temporary storage unit at the time of the substrate being loaded on the substrate loading part by the carrier arm;
a judgment module judging whether or not the vibration is abnormal vibration by comparing a current detection value of the vibration sensor with a predetermined set value; and
a carrier arm stop module stopping the carrier arm when the judgment module judges the vibration to be the abnormal vibration.

6. The recording medium as set forth in claim 5,
wherein the program further comprises a substrate collection module collecting the substrate supported by the carrier arm in a carriage container different from a normally used carriage container, when the judgment module judges the vibration to be the abnormal vibration.

7. The recording medium as set forth in claim 5,
wherein the program further comprises a substrate retreat module configured to cause the substrate supported by the carrier arm to temporarily retreat in a dummy FOUP or a dummy stocker when the judgment module judges the vibration to be the abnormal vibration.

8. A recording medium storing a program configured to cause s a computer to execute transfer of a substrate to a temporary storage unit by a carrier arm, the program comprising:
a vibration detection module detecting, by using a vibration sensor, vibration occurred from a substrate loading part of the temporary storage unit at the time of the substrate being loaded on the substrate loading part by the carrier arm;
a judgment module judging whether or not the vibration is abnormal vibration by comparing a current detection value of the vibration sensor with a predetermined set value; and
a substrate damage detection module detecting the substrate being damaged in a peripheral edge portion, based on the judgment of the abnormal vibration by the judgment module.

9. The recording medium as set forth in claim 8,
wherein the program further comprises a substrate collection module collecting the substrate supported by the carrier arm in a carriage container different from a normally used carriage container, when the judgment module judges the vibration to be the abnormal vibration.

10. The recording medium as set forth in claim 8,
wherein the program further comprises a substrate retreat module configured to cause the substrate supported by the carrier arm to temporarily retreat in a dummy FOUP or a dummy stocker when the judgment module judges the vibration to be the abnormal vibration.

11. A recording medium storing a program configured to cause a computer to execute transfer of a substrate to a temporary storage unit by a carrier arm, the program comprising:
a vibration detection module detecting, by using a vibration sensor, vibration occurred from a substrate loading part of the temporary storage unit at the time of the substrate being loaded on the substrate loading part by the carrier arm;
a judgment module judging whether or not the vibration is abnormal vibration by comparing a current detection value of the vibration sensor with a predetermined set value; and
a displacement detection module detecting the substrate being displaced in a process chamber or on a transfer route, based on the judgment of the abnormal vibration by the judgment module.

12. The recording medium as set forth in claim 11,
wherein the program further comprises a substrate collection module collecting the substrate supported by the carrier arm in a carriage container different from a normally used carriage container, when the judgment module judges the vibration to be the abnormal vibration.

13. The recording medium as set forth in claim 11,
wherein said program further comprises a substrate retreat module configured to cause the substrate supported by the carrier arm to temporarily retreat in a dummy FOUP or a dummy stocker when the judgment module judges the vibration to be the abnormal vibration.
